(19) United States
(12) Patent Application Publication
(10) Pub. No.: US 2024/0128539 A1
(43) Pub. Date: Apr. 18, 2024

(54) BATTERY MODULE AND PACKAGE THEREOF

(71) Applicant: ISUZU MOTORS LIMITED, Shinagawa-ku, Tokyo (JP)

(72) Inventor: Tomo MIZOGUCHI, Fujisawa-shi, Kanagawa (JP)

(21) Appl. No.: 18/546,530

(22) PCT Filed: Mar. 11, 2022
(86) PCT No.: PCT/JP2022/010997

§ 371 Date: Aug. 15, 2023

(30) Foreign Application Priority Data
Mar. 20, 2021 (JP) 2021-046708

(51) Int. Cl. H01M 10/6554; A62C 3/16; A62C 35/10; H01M 10/613; H01M 50/209; H01M 50/258

(52) U.S. Cl. CPC H01M 10/6554; A62C 3/16; A62C 35/10; H01M 10/613; H01M 50/209; H01M 50/258; H01M 2200/10

(57) ABSTRACT

A battery module includes a housing and a battery cell inside the housing. In the battery module, a fire extinguishing sheet is disposed on an upper surface side or a side surface side of the battery cell.

### CROSS-REFERENCE TO RELATED APPLICATIONS

The present application is a U.S. National Stage entry of PCT Application number PCT/JP2022/010997, filed on Mar. 11, 2022, which claims priority under 35 U.S.C § 119(a) to Japanese Patent Application No. 2021-046708, filed on Mar. 20, 2021, contents of which are incorporated herein by reference in their entirety.

### TECHNICAL FIELD

The present disclosure relates to a battery module and a package thereof.

### BACKGROUND OF THE INVENTION

A technique for installing a fire-extinguishing safety device in a battery pack is disclosed (Patent Document 1). Specifically, the fire-extinguishing safety device includes a fire extinguishing agent and a container containing the fire extinguishing agent, and prevents temperature rise in the battery pack by spraying the fire extinguishing agent when ignition or explosion occurs therein.

Further, disposing a heat-resistant, fire-spread prevention plate on the back side of a top cover of a module battery (Patent Document 2) is proposed. Even if there is a fire inside the module, the fire-spread prevention plate can prevent the fire from spreading over other modules in the package.

### PRIOR ART

### Patent Document

Japanese Unexamined Patent Application Publication No. 2007-20088
Japanese Unexamined Patent Application Publication No. 2014-67654

### BRIEF DESCRIPTION OF THE INVENTION

### Problem to be Solved by the Invention

Conventionally, there may be a fire in a battery module in which battery cells are arranged. As shown in FIGS. 3A and 3B, a conventional module 20 having a space 3 above battery cells 1 is used in order to deal with this problem. When there is a fire, such a space 3 prevents fire or gas from escaping and prevents other modules 20 from burning. On the other hand, the module 20 having such a space 3 has a large volume, and cannot meet the demand for downsizing the battery module.

Accordingly, an object of the present disclosure is to provide a battery module and a package thereof that meet the demand for downsizing, ensure safety when a battery cell ignites, and prevent fire spread.

Accordingly, an object of the present disclosure is to provide a battery module and a package thereof that meet the demand for downsizing, ensure safety when a battery cell ignites, and prevent fire spread.

### Means for Solving the Problem

An aspect of the present invention provides a battery module including a housing and a battery cell inside the housing, wherein a fire extinguishing sheet is disposed on an upper surface side or a side surface side of the battery cell.

A plurality of the battery cells may be arranged inside the housing, and a fire extinguishing sheet may be disposed on the upper surface side of the plurality of battery cells.

The battery cell may be a lithium-ion battery cell, a nickel-cadmium battery cell, a nickel-hydrogen battery cell, or a sodium-sulfur battery cell.

The fire extinguishing sheet may be a sheet to which a potassium compound or a sodium compound is applied.

A plurality of the battery cells may be arranged inside the housing, the fire extinguishing sheet may cover only a portion of upper surfaces of the plurality of battery cells, and a path through which gas or smoke flows may be formed in a region that is not covered with the fire extinguishing sheet on the upper surfaces of the plurality of battery cells inside the housing.

The plurality of battery cells may be arranged inside the housing, and the fire extinguishing sheet may cover the upper surfaces of the plurality of battery cells and may also cover side surfaces around the plurality of battery cells.

The fire extinguishing sheet may be attached to an inner top surface of the housing and an inner side surface of the housing.

An aspect of the present invention provides a battery package including: a rack; and a plurality of the above-described battery modules disposed in the rack.

The rack may have a top cover, and the fire extinguishing sheet may be disposed on a back side of the top cover, and the fire extinguishing sheet may be disposed on or above the battery cell in the housing over a plurality of modules.

### Effect of the Invention

According to the present disclosure, it is possible to provide a battery module and a package thereof that meet the demand for downsizing, ensure safety when a battery cell ignites, and prevent fire spread.

### BRIEF DESCRIPTION OF THE DRAWINGS

FIG. 1A is a perspective view schematically showing an example of a configuration of a battery module according to an embodiment of the present disclosure, and FIG. 1B is a cross-sectional view taken along the line A-A.

FIG. 2 is a perspective view schematically showing an example of a battery package in which a plurality of battery modules of the present disclosure are mounted.

FIG. 3A is a perspective view schematically showing an example of a configuration of a conventional battery module, and FIG. 3B is a cross-sectional view taken along the line B-B.

### DESCRIPTION OF EMBODIMENTS

Hereinafter, an embodiment of the present disclosure will be described while referencing the drawings. The same components are denoted by the same reference numerals, and their names and functions are also the same. Therefore, detailed description thereof will not be repeated.

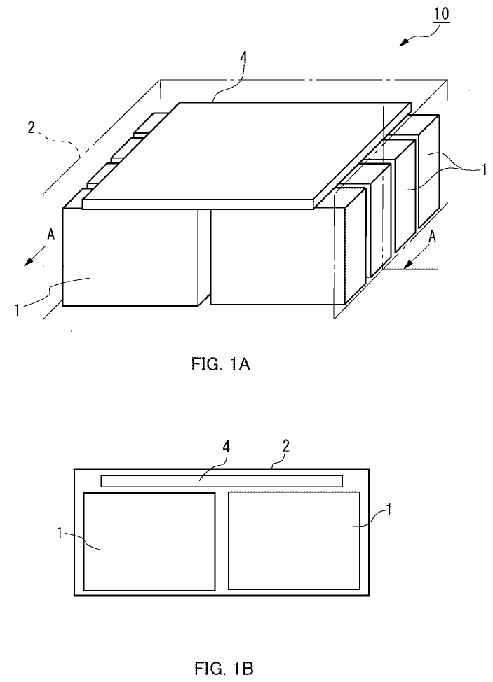

FIGS. 1A and 1B are perspective views schematically showing an example of a battery module according to an embodiment of the present disclosure. In a battery module 10 of the present disclosure, eight battery cells 1 are arranged inside a housing 2. A fire extinguishing sheet 4 is placed on the upper side of the battery cells 1.

The fire extinguishing sheet 4 is a sheet material to which a fire extinguishing agent is applied, for example. Specifically, the fire extinguishing agent, in an amount necessary for extinguishing an ignited battery cell 1, is applied to the fire extinguishing sheet 4. The fire extinguishing sheet 4 is preferably thin. The package can be downsized further the thinner the fire extinguishing sheet 4 is.

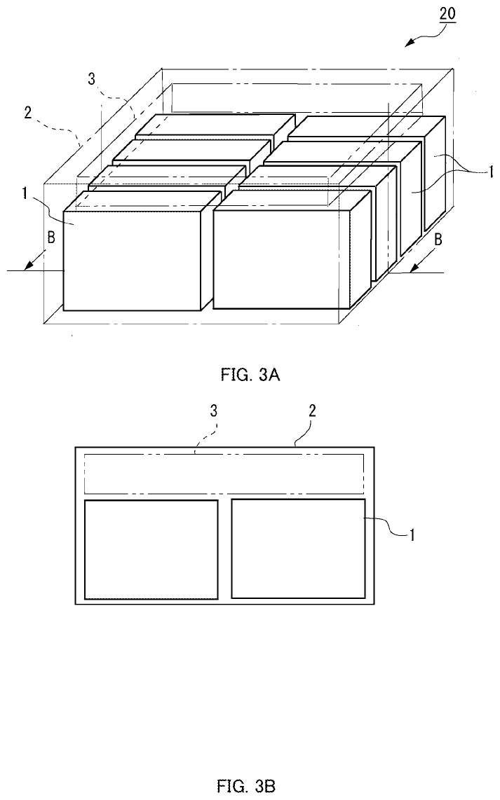

The conventional module 20 (FIGS. 3A and 3B) described above has a space 3 above the battery cells 1. This space 3 has been restricting downsizing. The battery module 10 of the present disclosure does not have such a space, and realizes downsizing by adopting a thinner, fire extinguishing sheet 4 (see FIGS. 1A and 1B).

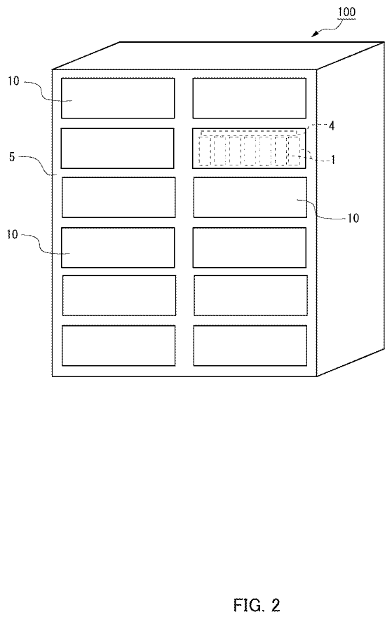

FIG. 2 is a perspective view showing an example of a battery package 100 in which a plurality of battery modules 10 of the present disclosure are mounted. In the embodiment of the present disclosure, the battery package 100 includes a rack 5. The rack 5 accommodates the plurality of battery modules 10. A large number of battery modules 10 are normally accommodated in a narrow space in this manner. Therefore, when there is ignition in one module, the fire may spread.

In the battery package 100 of the present disclosure, the battery module 10 includes the fire extinguishing sheet 4 as described above. Therefore, when the battery cell 1 ignites, the fire extinguishing agent of the fire extinguishing sheet 4 melts to extinguish the fire. Accordingly, it is possible to prevent the fire from spreading over other battery modules 10.

The fire extinguishing sheet 4 may be placed on the battery cell 1. The fire extinguishing sheet 4 may be attached to the back side of a top cover (not shown). As an example, the top cover is provided to the rack 5. The fire extinguishing sheet 4 may cover the plurality of modules 10. The top cover with the fire extinguishing sheet 4 attached thereto may cover the plurality of modules 10. That is, the fire extinguishing sheet 4 may be disposed not only on a single module but also on a package of the plurality of modules.

A configuration of the battery package 100 is not limited to the illustrated configuration, and may be another configuration. For example, when the battery package 100 is installed in a house, a package in which modules are placed in a vertical direction as shown in FIG. 2 is preferable.

When the battery package 100 is used as an on-vehicle battery, a plurality of battery modules 10 may be arranged in the horizontal direction, and the battery modules 10 may be connected to each other. Such an assembled battery may be provided in a floor portion of a vehicle body.

The fire extinguishing sheet 4 may cover not only the upper surface of the battery cell, but also side surfaces (a front surface, a back surface, a left surface, a right surface). This configuration also is useful and achieves desired effects. Also, a package may be of a cylindrical or pouch shape in addition to a rectangular shape. The module and its package of the present disclosure can also be applied to the configuration with the cylindrical or pouch shape. There may be a gap (space) between the battery cell and the fire extinguishing sheet on the upper surface side or the side surface side of the battery cell 1. Another functional sheet or the like may be interposed between the battery cell 1 and the fire extinguishing sheet 4.

The battery cell 1 used in the present disclosure may be a secondary battery cell or a primary battery cell. In view of ease of ignition, the present invention is more effective for a configuration using a secondary battery cell. Any secondary battery cell may be used. For example, the secondary battery cell may be a lithium-ion battery cell, a nickel-cadmium battery cell, a nickel-hydrogen battery cell, a sodium-sulfur battery cell, or the like. Although a structure of the battery cell 1 is not particularly limited, the battery cell 1 may have a structure in which a negative electrode active material is disposed on one side and a positive electrode active material is disposed on the other, and both of them are isolated by a solid electrolyte (not shown), for example. The solid electrolyte has selective permeability to ions such as lithium ions or sodium ions. Charging and discharging are performed by the movement of the ions on a wall surface of the solid electrolyte.

The fire extinguishing sheet 4 used in the present disclosure may be any type. The fire extinguishing agent may be, for example, sodium hydrogen carbonate, potassium hydrogen carbonate, phosphate (ammonium dihydrogen phosphate), a combination of potassium hydrogen carbonate and urea, or the like. Among them, in the present disclosure, the fire extinguishing sheet 4 to which a potassium compound or sodium compound is applied is preferable, and the fire extinguishing sheet 4 to which a potassium compound is applied is more preferable. The fire extinguishing sheet 4 is preferably disposed in direct contact with the battery cell 1. If necessary, another functional sheet or the like may be disposed between the battery cell 1 and the fire extinguishing sheet 4.

In the battery module 10 and the battery package 100 of the present disclosure, the fire extinguishing sheet 4 is disposed on the battery cells 1 that are arranged in each battery module 10. Accordingly, even if there is a fire in any one of the modules, it is possible to prevent the fire from spreading over other modules. Therefore, in the unlikely event of a fire, the fire is extinguished inside the module, which means there is no possibility that the fire becomes a serious fire.

Further, according to the battery module 10 of the present disclosure, the fire extinguishing agent puts out the fire immediately, which leads to greater safety. Further, the size of the housing 2 is smaller than that of the conventional housing that requires the space 3, which increases volume energy density. That is, according to the battery module of the present disclosure, it is possible to achieve both greater safety and higher volume energy density.

As shown in FIGS. 1A and 1B, the fire extinguishing sheet 4 may cover not all of the upper surfaces of the plurality of battery cells 1 but only a portion of the upper surfaces of the plurality of battery cells 1. A path through which gas or smoke flows may be formed in a region that is not covered with the fire extinguishing sheet 4 on the upper surfaces of the plurality of battery cells 1 inside the housing 2 (a region on the right side and the left side of the fire extinguishing sheet 4 in FIGS. 1A and 1B). The fire extinguishing sheet 4 may be disposed such that it covers the upper surfaces of the plurality of battery cells 1 and also covers side surfaces around the plurality of battery cells 1. In such a configuration, the fire extinguishing sheet 4 may be attached to an arbitrary member, but may be attached to an inner top surface of the housing 2 and an inner side surface of the housing 2. According to this configuration, since the housing 2 functions as a support member for the fire extinguishing sheet 4, it is possible to omit a member to which the fire extinguishing sheet 4 is attached.

### DESCRIPTION OF REFERENCE NUMERALS

1 battery cell
2 housing (battery case)
3 space
4 fire extinguishing sheet
5 rack
10 battery module
20 battery module of comparative example (conventional battery module)
100 battery package

1. A battery module comprising a housing and a battery cell inside the housing, wherein
a fire extinguishing sheet is disposed on an upper surface side or a side surface side of the battery cell.

2. The battery module according to claim 1, wherein
a plurality of the battery cells are arranged inside the housing, and
a fire extinguishing sheet is disposed on the upper surface side of the plurality of battery cells.

3. The battery module according to claim 1, wherein
the battery cell is a lithium-ion battery cell, a nickel-cadmium battery cell, a nickel-hydrogen battery cell, or a sodium-sulfur battery cell.

4. The battery module according to claim 1, wherein
the fire extinguishing sheet is a sheet to which a potassium compound or a sodium compound is applied.

5. The battery module according to claim 1, wherein
a plurality of the battery cells are arranged inside the housing,
the fire extinguishing sheet covers only a portion of upper surfaces of the plurality of battery cells, and
a path through which gas or smoke flows is formed in a region that is not covered with the fire extinguishing sheet on the upper surfaces of the plurality of battery cells inside the housing.

6. The battery module according to claim 1, wherein
the plurality of battery cells are arranged inside the housing, and
the fire extinguishing sheet covers the upper surfaces of the plurality of battery cells and also covers side surfaces around the plurality of battery cells.

7. The battery module according to claim 6, wherein
the fire extinguishing sheet is attached to an inner top surface of the housing and an inner side surface of the housing.

8. A battery package comprising:
a rack; and
a plurality of the battery modules disposed in the rack, according to claim 1.

9. The battery package according to claim 8, wherein
the rack has a top cover, and
the fire extinguishing sheet is disposed on a back side of the top cover, and the fire extinguishing sheet is disposed on or above the battery cell in the housing over a plurality of modules.
